(19) United States
(12) Patent Application Publication
(10) Pub. No.: US 2022/0388154 A1
(43) Pub. Date: Dec. 8, 2022

(54) IMPROVED DELTA ROBOT

(71) Applicant: Synapticon GMBH, Schonaich (DE)

(72) Inventors: Fabio GENTILI, Schonaich (DE); Andrija FEHER, Schonaich (DE); Nikolai ENSSLEN, Schonaich (DE)

(21) Appl. No.: 17/774,528

(22) PCT Filed: Dec. 9, 2020
(86) PCT No.: PCT/IB2020/061674

§ 371 Date: May 5, 2022

(30) Foreign Application Priority Data
Dec. 12, 2019 (DE) 10 2019 134 209.0

(51) Int. Cl. B25J 9/00; B25J 9/12

(52) U.S. Cl. CPC B25J 9/0051; B25J 9/126

(57) ABSTRACT

The invention relates to a delta robot (1) with at least two robot arms (2a, 2b, 2c), preferably three robot arms (2a, 2b, 2c), which can be moved relative to a robot base (3) via a respective motor (5a, 5b, 5c) arranged on the robot base (3) and associated with the respective robot arm (2a, 2b, 2c), wherein the motors (5a, 5b, 5c) each comprise part of a motor-controller-encoder unit (4a, 4b, 4c) with integrated servo-controller (6a, 6b, 6c) and encoder in order to increase the mechanical accuracy and efficiency of the delta robot (1).

The invention relates to a delta robot having at least two robot arms, preferably three robot arms, which are movable relative to a robot base via a respective motor-controller-encoder unit arranged on the robot base.

In general, the term delta robot or delta robot unit refers to a parallel arm robot or parallel arm robot unit with rod kinematics. Typically, three robot arms are linked to the robot base with universal joints. Robot arms can be segments of the kinematics that mechanically couple the base and end effector in parallel in a kinematic chain between the robot base and the effector. Such a robot arm can, for example, have a proximal and a distal (lower) robot arm, whereby the proximal (lower) robot arm couples the robot base with the distal (lower) robot arm and the distal (lower) robot arm couples the proximal (lower) robot arm with the effector. Accordingly, the described robot arms can also be understood as robot arm segments. A typical delta robot is described, for example, in US 2015 0 343 631 A1.

Delta robots are fast and light and are often used for packaging in factories and assembly, but also in the medical and pharmaceutical industries. Such delta robots can also be used for precise assembly work or in 3D printing. Due to their high precision, they are particularly suitable for gripping and placing objects and are accordingly also referred to and used as “pick-and-place robots”.

The robot arms of such a delta robot can form a closed kinematic chain in their cooperation. The robot arms thus correspond to axes of the delta robot. The robot base of the delta robot is usually mounted above the moving parts, for example suspended from a ceiling. From there, the robot arms extend downwards. The ends of the robot arms are connected to a common end effector, usually via a smaller triangular platform. If the axes of the robot arms are driven by one or more motors mounted on the robot base, the triangular platform mounted below, and thus the end effector, moves along respective travel paths in the X, Y and/or Z direction, corresponding to the side of a parallelogram.

Delta robots can be manufactured with two-, three-, four-, or five-axis/arm configurations. Depending on the number of degrees of freedom, delta robots can also perform rotational movements. In general, such a delta robot can be moved by both a linear drive and a rotary drive. Since the motors of the robot arms are not located in the joints but at the base, the robot arms are very light. This generates low inertia and thus high achievable speeds and accelerated in industrial application, so they are often used in fast activities with a high repetition rate.

However, with a large repetition rate of movements performed at high speed and large accelerations, the mechanical accuracy of the delta robot decreases noticeably over time.

Accordingly, the present invention is based on the task of increasing the mechanical accuracy and efficiency of a delta robot.

This task is solved by the subject-matter of the independent patent claim. Advantageous embodiments are shown in the dependent claims, the description and the FIGURE.

One aspect relates to a delta robot, which may also be referred to as a delta robot unit, having at least two robot arms (which may also be referred to as robot arm segments) which are movable relative to the robot base via a respective motor-controller-encoder unit located at the robot base. Each robot arm is thus moved via a motor-controller-encoder unit specifically assigned to this robot arm. Preferably, this is a delta robot with three robot arms, each of which can be moved relative to the robot base via a motor-controller-encoder unit arranged on the robot base and assigned to the respective robot arm. The robot arms can have a common end effector. i.e. be mechanically coupled to each other via a common end effector. They can thus form a closed kinematic chain via the common end effector, which is attached, for example, to the (distal) ends of the robot arms remote from the robot base. The respective motor of the motor-controller-encoder unit is attached with its stator to the robot base and with its rotor to the associated robot arm.

The motor-controller-encoder units have an integrated controller or servo-controller, often referred to as a “servo-drive”, and an integrated rotary encoder, also referred to as an “encoder”. As also specified below, the integrated components of the motor-controller-encoder unit may have a common housing. Thus, in operation, the motor-controller-encoder units only require a power supply and a communication signal for the (servo)controller, and in contrast to known solutions, no motor control signal (which includes a controlled electrical drive power) from an external, i.e. remote from the robot base, control cabinet or the like, since the entire control of the torque motor according to an externally provided communication signal takes place within the delta robot, i.e. within the respective motor-controller-encoder unit and thus the robot base.

This shortens the signal paths for the motor control signals of the servo controller, which has the effect of improving the accuracy of the delta robot. Moreover, the length of the signal paths is fixed by the manufacturer, which also improves the accuracy. With identically constructed motor-controller-encoder units, the signal paths between the motor and the servo-controller are thus also identical, which is, for example, only coincidentally the case with servo-controllers arranged externally in control cabinets.

In an advantageous embodiment, the motor-controller-encoder units each have a moment-of-force motor, a so-called “torque motor”, as a motor. In particular, a torque motor is a motor whose (radial) diameter is greater than an (axial) length. Diameter and/or length can denote the diameter or length of a rotor of the motor and/or the diameter or length of a stator of the motor. A torque motor can also mean a motor with a controllable torque, in particular with a torque controlled locally, i.e. within the robotic unit, here the delta robot (and not externally in a control cabinet), according to an external specification. The torque motor can also be a motor with a hollow shaft as a drive shaft, which facilitates and improves a supply of data and/or media, for example an air pressure, to the robot arm and the end effector.

Alternatively or additionally, the motor-controller-encoder units do not have any mechanical gears or gear units. Preferably, the delta robot as a whole does not have a gearbox, or at least no gearbox that is used to move the robot arms relative to the robot base.

The advantages follow from the effect that the use of the torque motors makes mechanical gears in the delta robot superfluous. It has been found that due to the typically limited rotation angles of the motors in the classic delta robots, in which the respective robot arms are moved with a commercially available servo motor via a mechanical transmission, a gearbox, lubricants are unevenly distributed in the gearbox and are accordingly locally present in insufficient quantities. Accordingly, the increased wear in the gears of the delta robots is a major cause of the loss of accuracy mentioned above. However, by using the torque motor, a gearbox is no longer required, which in turn creates space for the servo controller and encoder integrated in the motor-controller-encoder unit, so that the long-lasting increased accuracy is not accompanied by an additional installation space requirement.

In addition to the aforementioned advantages of increased accuracy, the absence of gears also has the advantage of noise reduction and component reduction, as well as the advantage of increased mechanical efficiency, since friction losses caused by gears and backlash that is always present in the gearbox are eliminated. Due to the absence of gears, the (rotary) encoder of the motor-controller-(rotary)encoder unit directly reflects the position of the robot arm, as there is no backlash between the motor and the robot arm, as is otherwise the case.

In a particularly preferred embodiment, the robot arms are each only mounted on the robot base via the bearing element(s) of the associated motor. This gives the advantage that the bearing elements already present in the motor, such as ball bearings, are used directly for the suspension of the robot arm. Such bearing elements are known to have relatively large cross-sections, especially in a torque motor, and therefore enable particularly precise guidance. This not only again reduces a space requirement, but also increases the overall rigidity of the robot arms and the delta robot and further reduces the overall tolerance between the robot base and the robot arms. Since the motors or torque motors with their stability are now an integral part of the robot mechanics, i.e. only via the motors or torque motors are the robot arms attached to the robot base, correspondingly then the (rotary) encoder of the motor-controller-(rotary)encoder unit is also arranged directly on the robot arm, which again improves the accuracy of the control of the robot arm.

In another advantageous embodiment, it is provided that the servo-controller and the encoder of the respective motor-controller-encoder units are arranged in a common housing. In particular, the torque motor and the servo-controller and the encoder of the respective motor-controller-encoder units may also be arranged in a common housing. The common housing may also comprise individual housings for said components, which are attached to each other, for example screwed or glued. This has the advantage that the individual components are already precisely matched to each other during manufacture, which in turn is beneficial to the accuracy of the delta robot as a whole.

In a further advantageous embodiment, it is provided that the motors are slew/swivel motors which can only perform rotations of less than 360°, in particular of less than 180° or less than 120° or less than 90°. In delta robots with areas of application in which the robot arms are only moved through such small angles, the achievable gains in accuracy are particularly large, since the disadvantages of the aforementioned approaches are particularly pronounced here.

In another advantageous embodiment, it is provided that the motor-controller-encoder units are designed for a low-voltage operating or supply voltage. In particular, the motor-controller-encoder units may be designed for an operating voltage of up to 60V or up to 50V, for example 48V. This has the advantage that the usual control cabinet for supplying the robot with the controlled drive power can be omitted and the operational reliability is increased. This is particularly advantageous for the common bus mentioned below, where the different motor-controller-encoder units can be connected in series to one connection.

Accordingly, in another advantageous embodiment, it is provided that the delta robot has only two electrical connections, namely one connection for supply current, the supply voltage, and one connection for a communication or control signal directed to the servo controllers. This not only saves on cables, but also reduces the likelihood of interference between the cables as well as losses in the accuracy of the delta robot due to faulty connections. This again reflects the advantageous concept of the servo controller and encoder being built into one unit with the motor, which makes it unnecessary to provide time-sensitive control signals via an external control device such as a control cabinet and thus cables of a length that cannot be influenced by the manufacturer of the delta robot.

In a further advantageous embodiment, it is provided that the delta robot has a common bus for supplying all motor-controller-encoder units with electrical supply current of the operating voltage and/or with the communication signal directed to the servo controllers, and the different motor-controller-encoder units are supplied with the operating voltage and/or with the communication signal via the common bus. The supply voltage and/or the communication signal can therefore be looped through the respective motor-controller-encoder units, which in turn saves cables and thus space. The delta robot can also be manufactured as a unit and only needs to be connected to the said bus at the place of use, i.e. exactly once and not several times with many different cables. Accordingly, sources of error in the cabling are minimised on the manufacturing side, since in principle only two plugs or a combination plug for the two connections have to be plugged in on site.

In a further advantageous embodiment, it may be provided that the motor-controller-encoder units each have an automatic safety function. For example, the safety function may comprise an automatic braking function, i.e. an automatic stopping of a movement if a fault is detected, and/or an safe torque off function, i.e. an automatic setting of a torque generated by the respective motor or torque motor to zero if a fault is detected.

In another advantageous embodiment, it can be provided that the motors are coupled on the drive side to a respective gear unit in order to move the respectively assigned robot arm, and the gear units are coupled on the output side to a further rotary encoder of the assigned motor-controller-(rotary)encoder unit. The motors thus drive the associated gear units, which in turn drive the respective robot arms with a respective output. The respective output of the gear units is coupled to the additional encoder (second encoder), which is read out by the controller of the motor-controller-encoder unit like the (first) encoder described above.

This has the advantage that the mechanical clearance of the gear unit can be compensated by the controller. Since the compensation is dynamic, a changing backlash of the gear unit over the lifetime of the delta robot is also compensated and thus an increased accuracy is achieved over the entire lifetime of the delta robot.

In particular, it can be provided that the motors each have a hollow shaft as a drive shaft and the further rotary encoder assigned to the respective motor-controller-rotary encoder unit is mechanically and/or electrically coupled, through the hollow shaft, to the output of the transmission unit. This has the advantage that respective mechanical and/or electrical coupling elements such as shafts and/or cables can run close to or even in the respective rotational axes, which conceptually simplifies the coupling. For example, a mechanical coupling between the output of the gear unit and the further encoder in the motor-controller-encoder unit can thus be realised via a second shaft running inside the hollow shaft with an identical axis of rotation. The additional encoder can also be arranged directly on the output of the gear unit and electrically coupled to the controller of the motor-controller-encoder unit via a cable running in the axis of rotation of the hollow shaft.

Another aspect also relates to a motor-controller-encoder unit for a delta robot according to any one of the described embodiments. The advantages and advantageous embodiments of the motor-controller-encoder unit result from the advantages and advantageous embodiments of the delta robot.

The features and combinations of features mentioned above in the description, as well as the features and combinations of features mentioned below in the description of the FIGURE and/or shown in the FIGURE alone, can be used not only in the combination indicated in each case, but also in other combinations, without leaving the scope of the invention. Thus, embodiments which are not explicitly shown and explained in the FIGURE but which arise from the explained embodiments and can be produced by separate combinations of features are also to be regarded as encompassed and disclosed by the invention. Embodiments and combinations of features are also to be regarded as disclosed which thus do not have all the features of an originally formulated independent claim. In addition, embodiments and combinations of features are to be regarded as disclosed, in particular by the embodiments set out above, which go beyond or deviate from the combinations of features set out in the recitations of the claims.

An exemplary embodiment of a delta robot is explained below with reference to a schematic drawing.

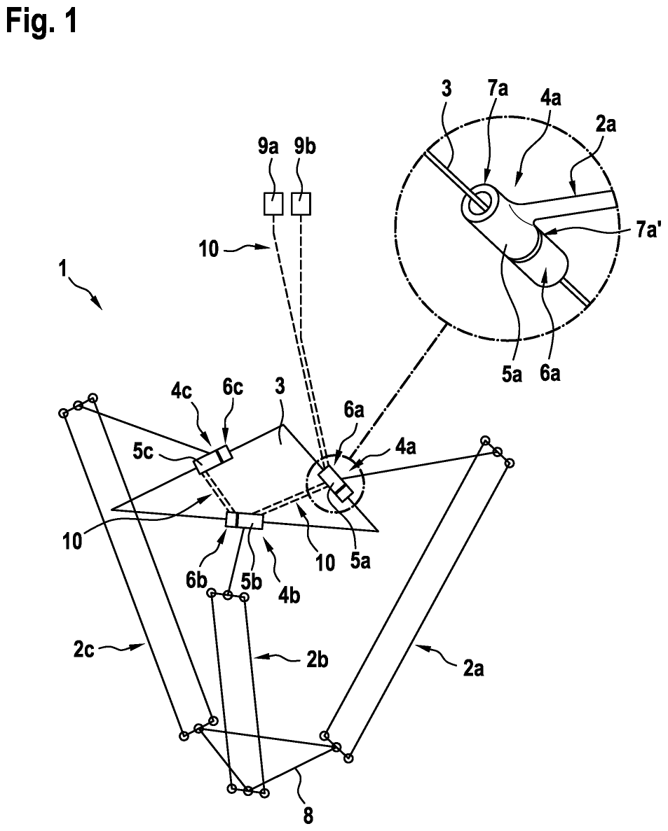

FIG. 1 shows a symbolic representation of an exemplary embodiment of a delta robot. In the present example, the delta robot 1 has three robot arms 2a, 2b, 2c, which can be moved relative to a robot base 3 by means of a motor-controller-rotator unit 4a, 4b, 4c arranged on the robot base 3 and assigned to the respective robot arm 2a, 2b, 2c. An end effector 8 is arranged at the ends of the robot arms 2a-2c that are further away from the robot base 3.

The motor-controller-encoder units 4a, 4b, 4c each have a motor 5a, 5b, 5c, which is designed as a torque motor here, and servo controllers 6a, 6b, 6c integrated into the motor-controller-encoder units 4a, 4b, 4c and encoders or rotary encoders that are not shown. Therein, the motor-controller-encoder units 4a-4c (as well as the robot arms, in particular in their proximal ends or sub-robot arms) do not have any gears. Rather, in the example shown, the robot arms 2a-2c are directly supported at their proximal end closest to the robot base 3 only via the bearing elements 7a, 7a′ of the associated torque motor 4a-4c on the robot base 3. In the example shown, the torque motor 4a is shown as an outrunner or outer rotor motor, in which the internal stator is connected to the robot base 3 and the outer rotor merges into the robot arm 2a, and consequently can also be understood as part of the robot arm 2a.

At present, the delta robot 1 has exactly two electrical connections 9a, 9b, namely a first connection 9a for the power supply with the operating voltage and a second connection 9b for a communication signal directed to the servo controllers 6a-6c. In the present case, the connections 9a, 9b are designed with a common bus 10 for supplying all motor-controller-encoder units 4a to 4c with the operating voltage and with the communication signal. For example, the delta robot 1 can be connected to an external power supply, such as a power supply network, via connection 9a and to an external control device, such as a computer, via connection 9b. The computer and power supply network are then connected to the first motor-controller-encoder unit 4a via the bus 10 in the example shown. This first motor-controller-encoder unit 4a is in turn correspondingly connected via the common bus 10 to the next motor-controller-encoder unit 4b, which is in turn coupled via the bus 10 to the motor-controller-encoder unit 4c. Also by using the bus 10 and “looping” the signals through or via the various motor-controller-encoder units 4a, 4b, 4c, signal path lengths are thus minimised and it is contributed to improved accuracy.

1. A Delta robot with at least two robot arms, which can be moved relative to a robot base by means of a respective motor arranged on the robot base and associated with the respective robot arm, characterized in that the motors each comprise part of a motor-controller-encoder unit with an integrated controller and integrated encoder.

2. A Delta robot according to claim 1, characterized in that the motor-controller-encoder units have no gears and/or the motors of the motor-controller-encoder units are torque motors.

3. A Delta robot according to claim 1, characterized in that the robot arms are each mounted on the robot base only via the bearing element or elements of the associated motor.

4. A Delta robot according to claim 1, characterized in that the controller and the encoder of the respective motor-controller-encoder units are arranged in a common housing, in particular the motor and the controller and the encoder of the respective motor-controller-encoder units are arranged in a common housing.

5. A Delta robot according to claim 1, characterized in that the motors are designed for slewing functions which can only perform rotations of less than 360°, in particular less than 180°.

6. A Delta robot according to claim 1, characterized in that the motor-controller-encoder units are designed for a low-voltage operating voltage, in particular for an operating voltage of up to 60V or up to 50V, for example 48V.

7. A-Delta robot according to claim 1, characterized in that the delta robot has only two electrical connections, namely one connection for the supply voltage and one connection for a communication signal directed to the controllers.

8. A Delta robot according to claim 1, characterized in that the delta robot has a common bus for supplying all motor-controller-encoder units with the supply voltage and/or with the communication signal, and the different motor-controller-encoder units are supplied with the supply voltage and/or with the communication signal via the common bus.

9. A Delta robot according to claim 1, characterized in that the motor-controller-encoder units have an automatic safety function, in particular a safe brake control function and/or a safe torque off function.

10. A Delta robot according to claim 9, characterized in that the motors, for moving the respectively associated robot arm, are coupled to the drive side of a respective gear unit, and the gear units are each coupled on the output side to a further rotary encoder of the associated motor-controller-encoder unit.

11. A Delta robot according to claim 10, characterized in that the motors each have a hollow shaft as a drive shaft and the further rotary encoder associated with the respective motor-controller-encoder unit is mechanically and/or electrically coupled, through the hollow shaft, to the output of the transmission unit.

12. A Motor-controller-encoder unit for the delta robot.
